(19) United States
(12) Patent Application Publication
(10) Pub. No.: US 2026/0364816 A1
(43) Pub. Date: Nov. 19, 2026

(54) DISPENSING SYSTEM AND RETURN SYSTEM

(71) Applicant: ScorpiusOne, Inc., Cincinnati, OH (US)

(72) Inventors: John M. SAVAGE, Cincinnati, OH (US); Robert Paul BASIL, Lawrenceville, GA (US); Mark Joseph MONEYPENNY, Postdam, NY (US); Brian Andrew WONG SHUI, Atlanta, GA (US); Erick Eladio RIOS, New Haven, CT (US)

(21) Appl. No.: 19/677,373

(22) Filed: May 14, 2026

Related U.S. Application Data
(60) Provisional application No. 63/805,565, filed on May 14, 2025.

(51) Int. Cl. B25J 11/00; B25J 5/02; B25J 9/00; B25J 9/16; B25J 13/08; B25J 15/00; B25J 15/08

(52) U.S. Cl. CPC B25J 11/008; B25J 5/02; B25J 9/0093; B25J 9/1664; B25J 9/1679; B25J 13/087; B25J 15/0014; B25J 15/08

(57) ABSTRACT

A dispensing system including a frame having a plurality of compartments, where each compartment is configured to receive at least one item therein. The frame further includes a pickup location. The system has a gripping assembly including gripping component having a pair of fingers that are movable closer to and further from each other to thereby selectively grip an item therebetween. The gripping assembly has a support arm positionable below the gripping component to selectively support the gripped item thereon. The gripping assembly is movable to the plurality of compartments and is also movable to a drop-off location that is in communication with the pickup location to thereby deliver the gripped item to the pickup location.

This application claims priority to U.S. Provisional Application Ser. No. 63/805,565 entitled DISPENSING SYTEM AND RETURN SYSTEM filed on May 14, 2025, the entire contents of which are hereby incorporated by reference.

The present invention is directed to, in one embodiment, a dispensing system, and more particularly, to a dispensing system that can grip and dispense items. In another embodiment present invention is directed to return system, and more particularly, to a return system that can relatively evenly distribute returned items.

### BACKGROUND

Self-service storage and dispensing units can be used to deliver a garment or the like to a pickup location so that the user/operator can receive the dispensed garment. However, existing storage and dispensing units can have various deficiencies, including having catch points upon which garments can bind or snag, requiring the dispensed garment to be bound within a bag or the like, and dispensing items that pile up in an unorganized manner.

Return systems can be used to receive a garment or the like from a user for further processing, such as cleaning, repair, redistribution and/or destruction. However many existing return systems include a simple chute which receives the returned items, and the returned items can pile up at the bottom of the chute in a manner that causes the chute to fill quickly.

### SUMMARY

In one embodiment the present invention is a dispensing system including a frame having a plurality of compartments, where each compartment is configured to receive at least one item therein. The frame further includes a pickup location. The system has a gripping assembly including gripping component having a pair of fingers that are movable closer to and further from each other to thereby selectively grip an item therebetween. The gripping assembly has a support arm positionable below the gripping component to selectively support the gripped item thereon. The gripping assembly is movable to the plurality of compartments and is also movable to a drop-off location that is in communication with the pickup location to thereby deliver the gripped item to the pickup location.

In another embodiment, the present invention is a handling system including a chute configured to receive items therein, and a distribution plate positioned in or adjacent to the chute such that the items that fall off of the distribution plate fall through the chute. The distribution plate includes a first protrusion on a first side and adjacent to a first lateral end thereof, a first landing space positioned adjacent to the first protrusion on the first side, a second protrusion on a second, opposite side thereof and adjacent to a second lateral end thereof, and a second landing space positioned adjacent to the second protrusion on the second side. The distribution plate is rotatable about a horizontal axis such that when the distribution plate is rotated, items positioned on an upper side of the distribution plate slide off the distribution plate and are deposited at a bottom portion of the chute.

### BRIEF DESCRIPTION OF THE DRAWINGS

FIG. 1 is a front exterior perspective view of a dispensing system, shown in conjunction with a user;

FIG. 2 is a front interior perspective view of the system of FIG. 1, showing the gripping assembly in an upper position;

FIG. 3 is front view of the system of FIG. 1;

FIG. 4 is a side view of the system of FIG. 3;

FIG. 5 is a side view of the system of FIG. 4, showing the upper gripping assembly in a relatively lower position;

FIG. 6 is a detailed perspective view of the system of FIG. 5, with the upper gripping assembly in contact with a clothing item;

FIG. 7 shows the system of FIG. 6, with the gripping assembly gripping the clothing item;

FIG. 8 is a side view of the gripping assembly and clothing item of FIG. 7, with the gripping assembly partially lifting the gripped clothing item away from an underlying stack;

FIG. 9 shows the system of FIG. 8, with the support arm moved under the clothing item;

FIG. 10 is an upper view of the gripping assembly and clothing item of FIG. 6, showing a range of motion of the gripping assembly;

FIG. 11 is an upper perspective view of the gripping assembly and clothing item of FIG. 9;

FIG. 12 is a side view of the system of FIG. 5, showing the gripping assembly gripping a clothing item moved to an upper position;

FIG. 13 is a front view of the system of FIG. 12;

FIG. 14 shows the system of FIG. 13, with the gripping assembly and clothing item moved to a drop-off location;

FIG. 15 shows the system of FIG. 14, with the clothing item dopped into a pickup location;

FIG. 15A is an alternate embodiment of the system of FIG. 14;

FIG. 16 is a front view of the system of FIG. 1, with a user accessing the clothing item at the pickup location;

FIG. 17 is a front exterior perspective view of a return system, shown in conjunction with a user and with an access door in a closed position;

FIG. 18 is a front view of the return system of FIG. 17, with the access door in an open position and showing the chute or a portion thereof in hidden lines;

FIG. 19 is a front perspective view a distribution plate of the system of FIG. 17, with a clothing item positioned thereon;

FIG. 20 shows the distribution plate of FIG. 19, pivoted forwardly, with the clothing item sliding off the distribution plate;

FIG. 21 shows the distribution plate of FIG. 20, pivoted further forwardly and another clothing items positioned on the distribution plate; and

FIG. 22 shows a pile of clothing items deposited by the distribution plate of FIG. 19.

### DETAILED DESCRIPTION

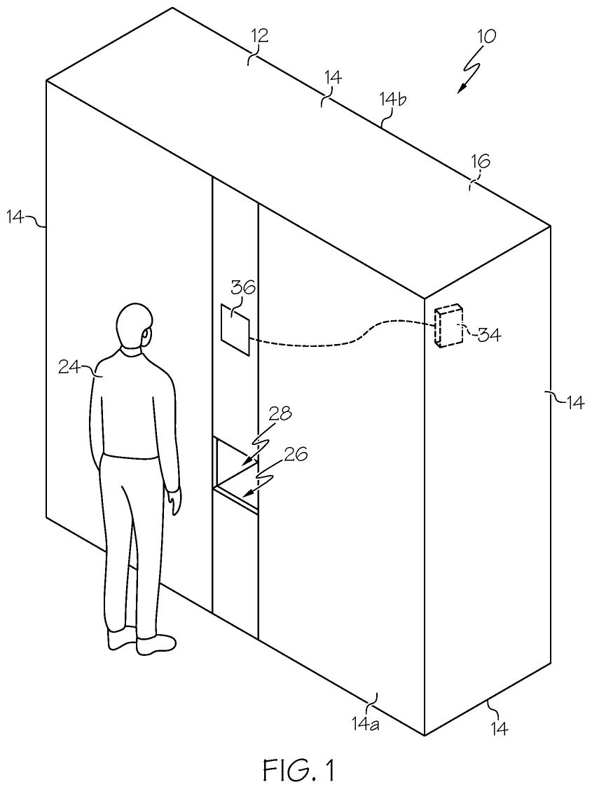

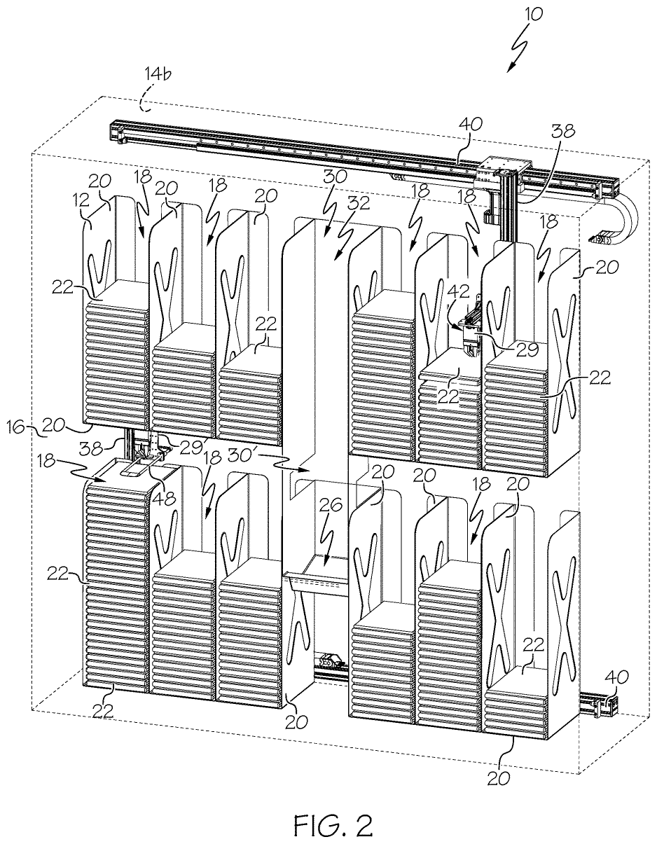

With reference to FIG. 1, a dispensing system 10, including a frame 12, is shown which can be utilized to store and/or dispense any of a wide variety of items. The system 10/frame 12 can include a set of outer walls 14, defining an inner cavity 16 therein. With reference to FIG. 2, the system 10/frame 12 can include plurality of compartments 18 positioned in the inner cavity 16. The compartments 18 can in one case be shaped as generally rectangular prisms, and be arranged in a series of rows and columns. Each compartment 18 can be defined by and/or separated from any adjacent compartments by various separators/walls 20 positioned on one or more sides of the compartment 18. In the illustrated embodiment the separators 20 include or take the form of vertically oriented walls and/or horizontally oriented walls. Each compartment 18 can be configured to receive at least one item 22 therein.

The system 10/frame 12 can be configured such that the plurality of compartments 18 are not directly accessible to a user 24 positioned outside the system 10/frame 12. In particular, the outer walls 14 can generally entirely cover the system 10/frame 12 and inner cavity 16 and/or block access, by a user 24 positioned outside the system 10/frame 12, to the one or all of the compartments 18. One or both of a front wall 14a and/or rear wall 14b of the outer walls 14 can be partially and/or fully removable to provide access to the compartments 18 for service or maintenance, and to stock/unstock items 22 in the compartments 18. However such direct access to the compartments 18 may be restricted to certain authorized users, such as maintenance and service personnel via locks, secure fasteners, and the like, and most users of the system would not have direct access to the compartments 18.

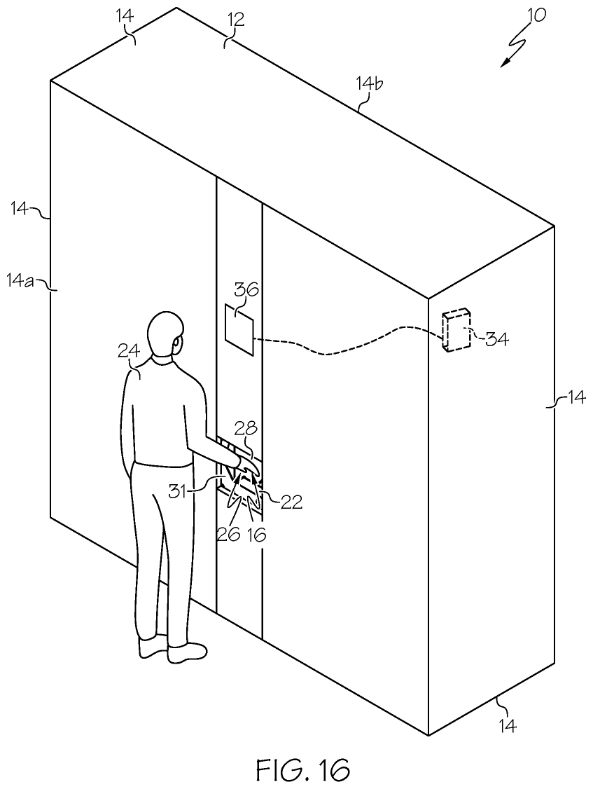

The system 10/frame 12 can include a pickup location 26, which in one case is not covered by the outer walls 14 and/or is defined by and/or accessible via opening 28 in the front wall 14a, and can be directly accessible to the user 24. In one case the system 10/frame 12 includes an openable/closeable door, flap or the like 31 (FIG. 16) that can be manually opened by the user 24, while the user's torso remains positioned outside the system 10/frame 12 to enable the user 24 to access the pickup location 26 and access/remove an item 22 position in/at the pickup location 26. However the system 10/pickup location 26 does not necessarily need to include a door 31 or the like and instead the pickup location 26 can be directly accessible to the user 24, without having to open a door or the like, as shown in FIG. 1.

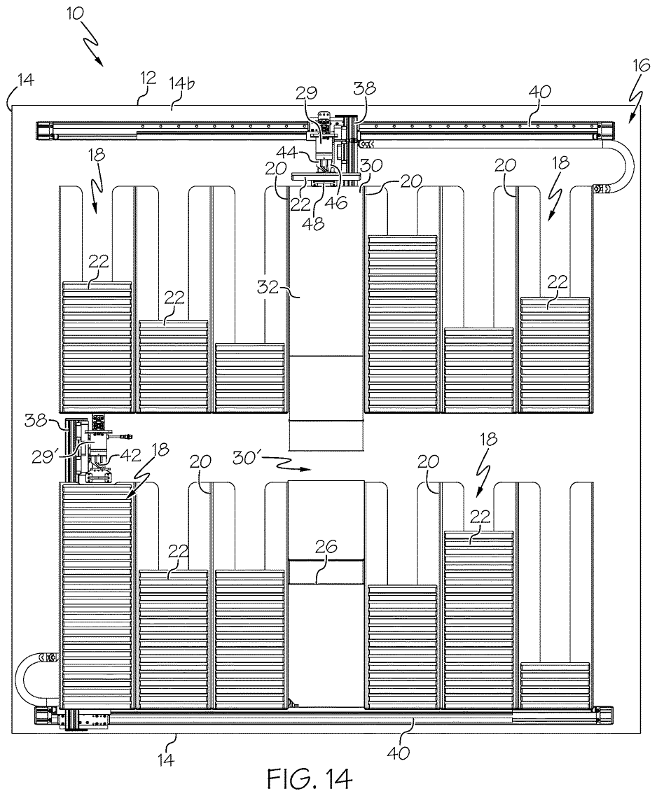

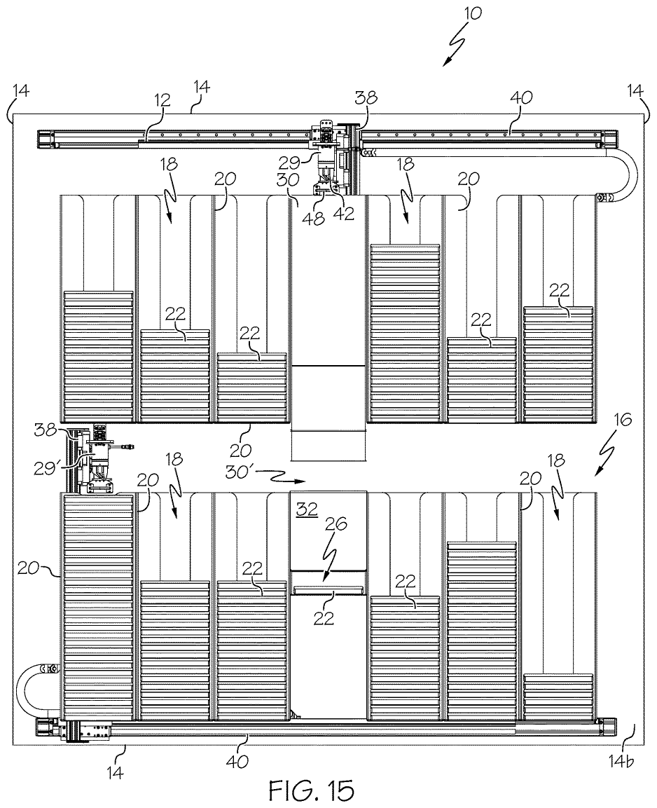

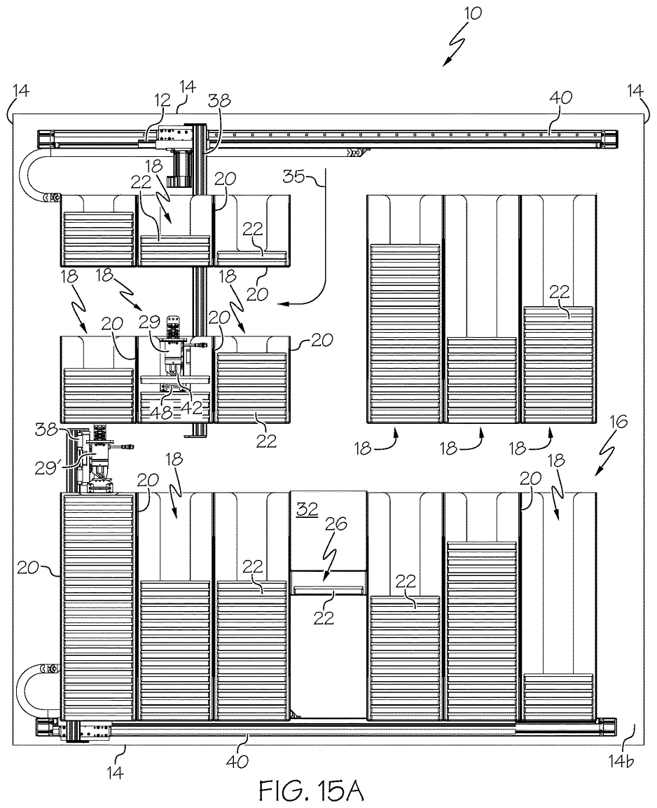

The system 10/frame 12 can include one or more movable gripping assemblies 29 positioned therein that is movable to one, more, or all of the compartments 18 to thereby grip and remove one or more items 22 stored or positioned in the compartments 18. The gripping assembly 29 can move the gripped item 22 to a drop-off location 30 positioned in/above a chute 32 (FIG. 14). The item 22 can be dropped at the drop-off location 30 and fall to the pickup location 26 of the system 10/frame 12 (FIG. 15).

Returning to FIG. 1, the system 10/frame 12 may include or be operatively coupled to a controller 34, which in turn can include and/or be operatively coupled to a user interface 36. The user 24 can interact with the user interface 36, to request delivery of items 22 positioned in the system 10/frame 12. The controller 34 may take the form of a processor, CPU, computer or the like, and the user interface 36 can take the form of a keypad, touch screen, keyboard, mouse, track ball, audio input device, or the like, and combinations thereof. In certain cases the controller 34 can be remotely positioned and/or the user interface 36 is also or instead remotely positioned, such as being presented to the user 24 via an app on the user's mobile phone, mobile device or the like.

The system 10/frame 12 can be used to store and dispense of any of a wide variety of items, products or the like (collectively terms “items” herein) so long as such items 22 can be physically accommodated in the system 10/frame 12, and in the case of items 22 to be dispensed, can be gripped/dispensed by the gripping assembly 29. Thus the items 22 can include, but are not limited to, garments, clothing, textiles including sheets, blankets and bedding, masks, gloves and other personal protective equipment, medical equipment, pharmaceuticals, retail merchandise, parts, components, work pieces, hardware, electronic equipment, food items, and like. In one case items 22 are garments/clothing items, and more particularly in one case each garment/item 22 is not encased in an outer bag and/or is in a folded configuration, as will be described in greater detail below.

As noted above, the system 10/frame 12 can include one or more gripping assemblies 29 that are movable in the horizontal direction and/or vertical direction, with respect to a gravitational frame of reference. In one case, with reference to FIG. 2, each gripping assembly 29, 29′, along with an associated vertical rail 38, is movable along a horizontally oriented rail 40 to access all compartments 18 in the same horizontal row. In the illustrated embodiment, the upper horizontal rail 40 is positioned above the associated row of compartments 18, and the lower horizontal rail 40 is positioned below the associated row of compartments 18. In this manner each gripping assembly 29, 29′ is movable horizontally in the frame 12 along the associated horizontal rail 40 to access one, more or all of the compartments 18 in that row. Each gripping assembly 29 is also movable vertically along the associated vertical rail 38, and in this manner each gripping assembly 29 can be vertically movable along an entire or substantially an entire height of each associated compartment 18, to thereby grip and dispense an item 22 stored in the accessed compartment 18. In one case each gripping assembly 29, 29′ is entirely positioned within, and contained within, the frame 12.

This system 10/frame 12 can include a first 29 and a second, or supplemental, gripping assembly 29′. In the illustrated embodiment the first/upper gripping assembly 29 is configured to access only the upper row of the compartments 18 and not able to access the lower row of compartments 18. Conversely the supplemental/lower gripping assembly 29′ can be configured to access only the lower row of compartments 18, and not be able to access the upper row of compartments 18. However the range of movement and accessibility of the gripping assemblies 29, 29′ can vary as desired, and in one case one or both gripping assemblies 29, 29′ can access more than one row of compartments 18, or multiple gripping assemblies 29 can access a single row of compartments 18. In addition, various other additional gripping assemblies 29 can be used, or, alternatively, only a single gripping assembly 29 may be used. Each gripping assembly 29 can, in one case, be independently movable relative to any other gripping assembly 29 in the horizontal and/or vertical direction.

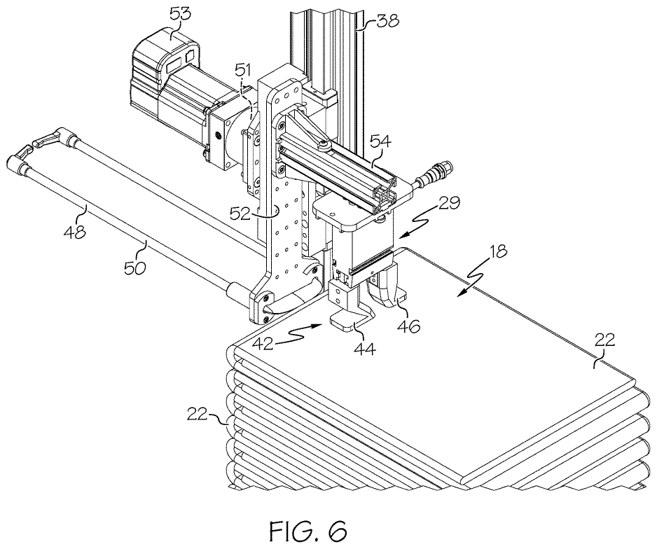

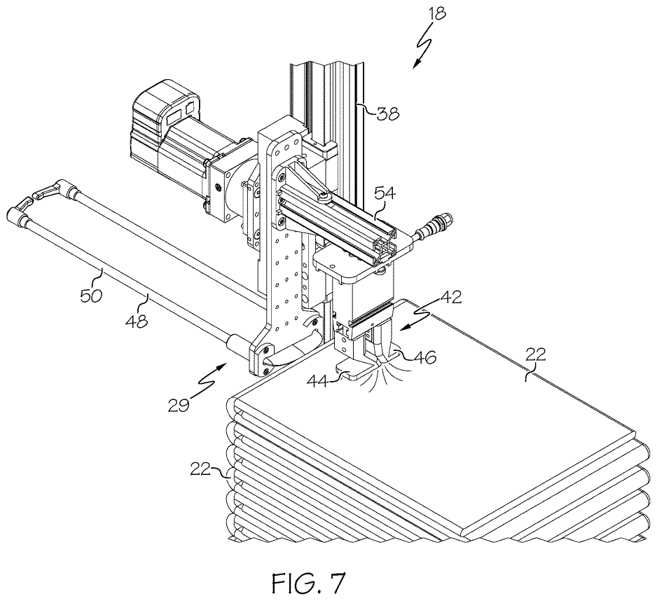

With reference to FIGS. 6 and 7, each gripping assembly 29 can include gripping component 42 having a pair of fingers 44, 46 that are movable closer to and further from each other, in the horizontal direction, to thereby selectively grip and release an item 22 therebetween. One or each finger 44, 46 can include a frictional gripping surface thereon, such as elastomers, synthetic rubber, rubber, polymers, etc. to aid in gripping the associated item 22.

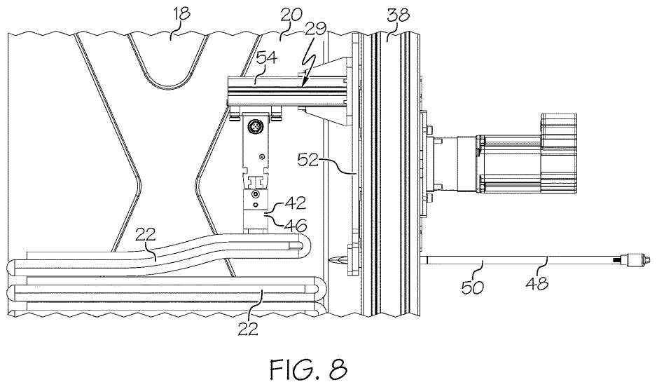

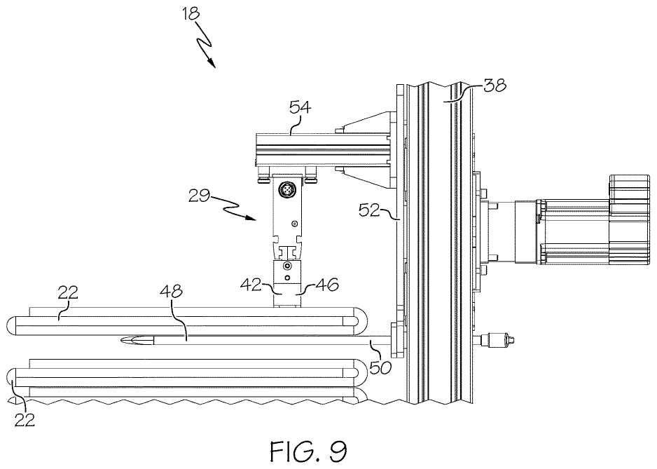

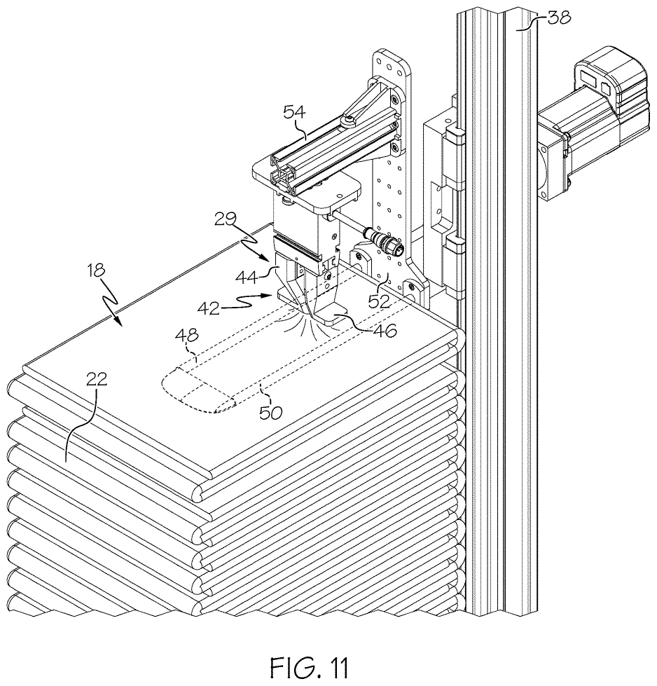

Each gripping assembly 29 can further include support arm 48 positioned vertically below the gripping component 42. The support arm 48 is movable in a horizontal direction relative to the gripping component 42, between a retracted position as shown in FIGS. 6-8, and an engaged position as shown in FIGS. 9-11. In one case, when the support arm 48 is in the retracted position, no portion of the support arm 48 is positioned directly below gripping component 42 and/or one or both fingers 44, 46 in the vertical direction (e.g. when viewed in side view as shown in FIG. 8). Similarly, in one case, when the support arm 48 is in the engaged position at least part of the support arm 48 is positioned directly vertically below the gripping component 42 and/or one or both fingers 44, 46 in side view (as shown in FIG. 9), and/or part of the support arm 48 is located on both lateral sides of the gripping component 42 and/or fingers 44, 46, in the horizontal direction, in front view (as shown in FIG. 11).

In one case the support arm 48 is directly coupled to and/or movable with the gripping component 42. More particularly in one case the support arm 48 is configured to move with the gripping component 42 when the gripping component 42 and/or gripping assembly 29 moves along the rails 38, 40 in the horizontal and/or vertical directions. Even more particularly, in one case the support arm 48 is not movable relative to the associated gripping component 42 in the vertical direction.

The gripping component 42 can include an extension portion 52 coupled to, and oriented perpendicular to, the support portion 50 to enable the support arm 48 to be coupled to a support block 54, which is in turn coupled to the gripping component 42. In the illustrated embodiment the support arm 48 includes a support portion 50 in the form of a bar formed in a generally flat “U” shape. The support arm 48/support portion 50 can take any of a wide variety of shapes and configurations beyond the “U” shape shown herein, but in one case can have a generally flat and/or planar shape. In one case the support arm 48/support portion 50 has a length of a least 50%, and/or less than 150%, of a length of the associated item 22 and/or compartment 18 (where the length is measured in a horizontal plane in the direction of movement of the support arm 48/support portion 50). In one case the support arm 48/support portion 50 has a width at least 20% and/or less than 100% in one case, or less than 150% in another case, of a width of the associated item 22 and/or compartment 18 (where the width is measured in a horizontal plane perpendicular to the length referenced above). The support arm 48/support portion 50 can have rounded leading edges and/or be made of a relatively slick, low friction material, to enable the support arm 48/support portion 50 to slide below an item 22, as will be described in greater detail below.

When a user 24 wishes to access and receive an item 22 from the system 10/frame 12, the user 24 may, in some cases, need to first be identified and/or authenticated (i.e. via an identification system and authentication system/database that is included in or operatively coupled to the controller 34 and/or user interface 36). The identification/authentication can be implemented or carried out in a variety of manners, including by a user identification and/or password, the use of a key fob or other wireless device which transmits in the radio frequency range, a mechanical or electronic key, the use of a mobile phone or device, a card with a chip/magnetic strip, the use of facial recognition or other biometrics, push authentication, or various other means or mechanisms. Once the user 24 is identified and/or authenticated, the user 24 may be granted access to all or only certain items 22 and/or certain compartments 18, based upon predetermined criteria. The controller 34 may track the identity and number of items 22 that are dispensed to that user, along with the time of dispensing.

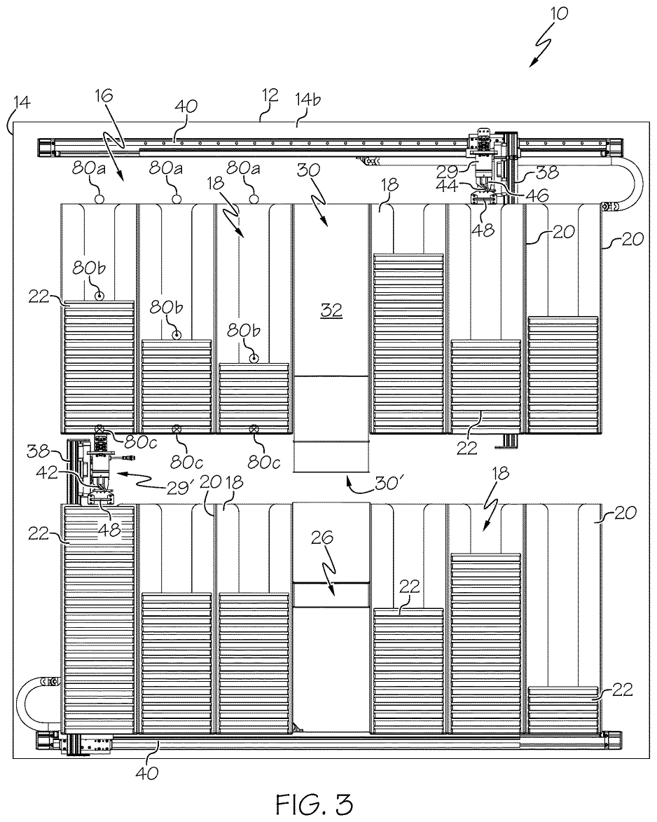

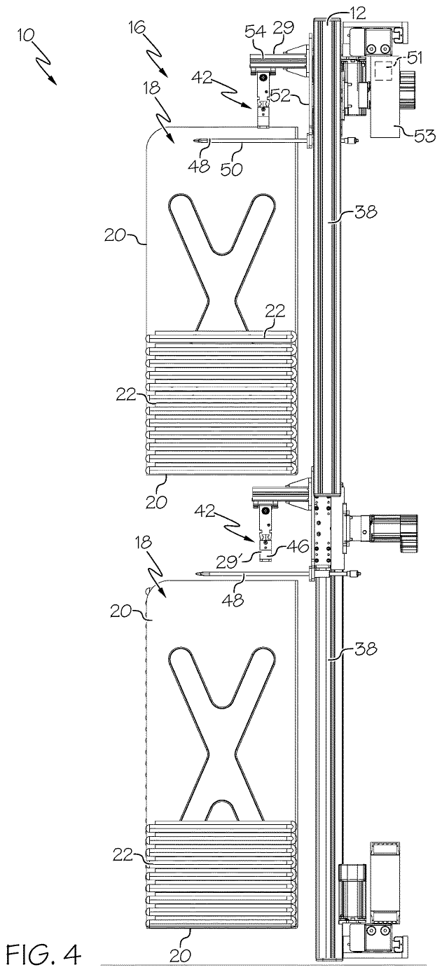

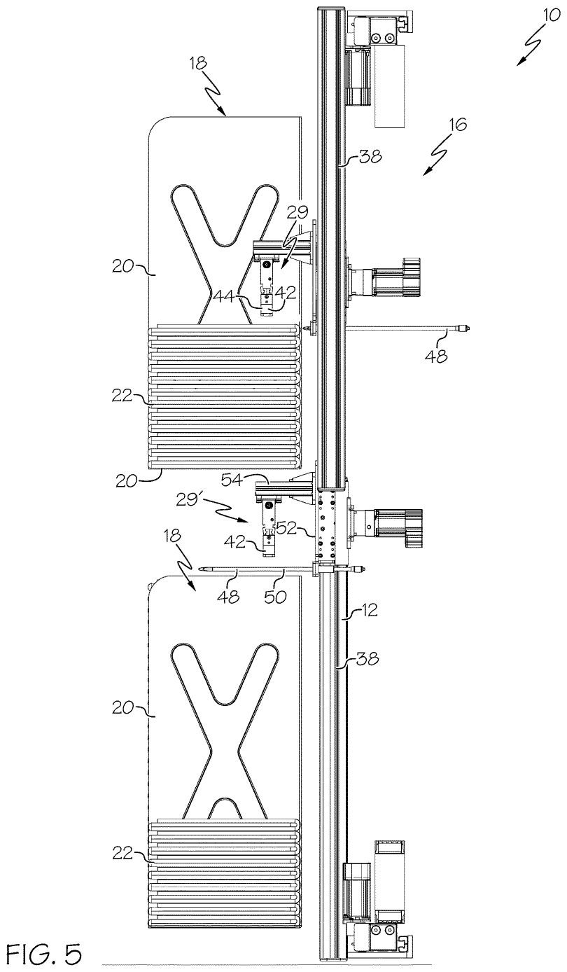

Once the user 24 is authenticated (if desired), the user 24 identifies, via the user interface 36, the items 22 that the user 24 desires to receive. In other cases, the user 24 may not need to be authenticated at the system 10, but instead can communicate with the system 10/user interface 36 remotely via an app on the user's phone or other mobile device and the app can in turn communicate the order to the system 10/user interface 36. Once the controller 34 determines that the item(s) 22 desired to be retrieved is stored/inventoried in the system 10/frame 12 and that the user 24 is authorized to receive the item(s) 22, the appropriate gripping assembly 29 is moved (e.g. in the horizontal direction) along the associated horizontal rail 40 until the gripping assembly 29 is aligned with (e.g. positioned above, in the illustrated embodiment) the compartment 18 of the item(s) 22 to be dispensed, as shown in FIGS. 3 and 4. Next, the gripping assembly 29 is moved/lowered, in the vertical direction along the vertical rail 38, until the gripping assembly 29 is positioned adjacent to the item 22 to be gripped/dispensed, as shown in FIG. 5.

The fingers 44, 46 of the gripping component 42 are then spaced apart (if not already spaced apart) and the gripping assembly 29/gripping component 42 is then lowered until the gripping component 42/fingers 44, 46 are in contact with the item 22, as shown in FIG. 6. The gripping assembly 29/gripping component 42 can be pressed slightly into the item 22, compressing the item 22 therebelow in some cases, to ensure a sufficient grip for the next step. The fingers 44, 46 are then moved together, frictionally gripping an upper part of the item 22 therebetween, as shown in FIG. 7. The gripping assembly 29/gripping component 42 is then moved in the vertical direction, partially raising and/or raising part of the item 22, as shown in FIG. 8, while the remainder of the item 22 remains supported by/resting on the underlying stack/item 22.

In one case, at this stage, the item 22 is lifted at least one inch, or is lifted by a distance equal to less than 10% in one case, or equal to or less than 25% in another case, or equal to or less than 50% in yet another case, of a greatest dimension of the item 22 (e.g. length or width), or is lifted at least about 10% in one case, or at least about 25% in another case, or at least about 50% in another case, of the greatest dimension. Each item 22 can have sufficient flexibility/pliability that when the item 22 is gripped and lifted by the amounts identified above, part of the item 22 remains in contact with and at least partially supported by an underlying item 22 and/or horizontal wall 20 of the compartment 18. While the item 22 remains partially lifted, the support arm 48/support portion 50 moves from its retracted position (FIG. 8) to its extended position (FIG. 9). The support arm 48/support portion 50 may thus move from the retracted position to the extended position while the gripping assembly 29/gripping component 42 is gripping the item 22, and in one case the gripping component 42 remains stationary during such movement of the support arm 48/support portion 50. When in the extended position, the support arm 48/support portion 50 may underlie at least about 50%, and in one case at least about 75% of length of the item 22, along the direction of movement of the support arm 48/support portion 50.

In one case one or more force sensors 51 (FIGS. 4 and 6) is operatively connected to the gripping assembly 29/gripping component 42. The force sensor 51 can be positioned in and/or coupled to the motor 53 that moves the gripping assembly 29/gripping component 42 in the vertical (Y) direction. In one case the force sensor 51 can detect vertical displacement of the cantilevered support block 54, to thereby determine the force applied to the gripping assembly 29/gripping component 42 in the vertical direction, such as by the top of the stack of garments 22.

The force sensor(s) 51 can be operatively coupled to the controller 34, and is configured to sense a force when the gripping assembly 29/gripping component 42 is lowered onto, and/or contacts, the top of a stack of garments 22. The gripping assembly 29/gripping component 42 can then be moved further downwardly, compressing the stack of garments 22. Once a first threshold force is sensed (e.g. once the stack of garments 22 is compressed a predetermined amount), the system/controller 34 thereby knows the height/location of the top of the stack of garments 22 and/or the amount of applied compression. The gripping assembly 29/gripping component 42 is then raised until the force sensor(s) 51 senses a second threshold force (less than the first threshold force, but greater than zero, in one case), thereby enabling the stack of garments 22 to at least partially decompress. Thus after the second threshold is met, the support arm 48/support portion 50 is extended to be slid under the top garment 22 of the stack of garments 22.

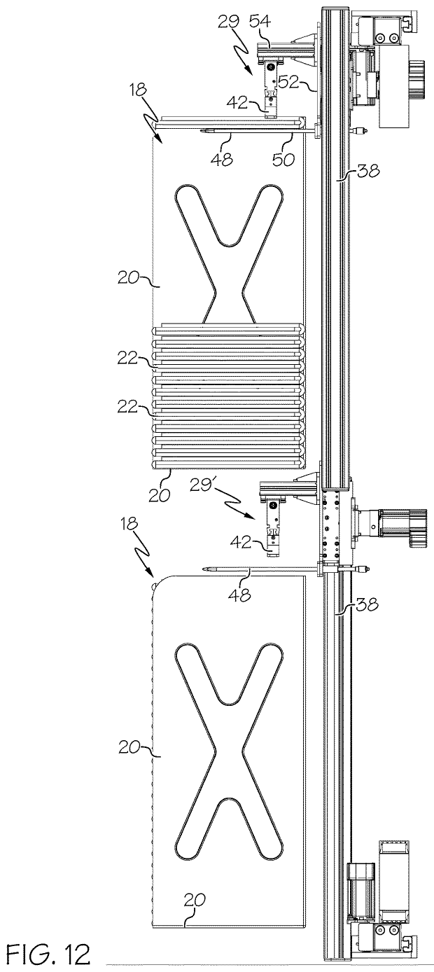

In this manner, once fully moved to the extended position the support arm 48/support portion 50 supports or at least partially supports the item 22 thereon. The gripping assembly 29 can then be moved vertically upwardly, lifting the item 22 entirely away from the underlying stack of items 22/horizontal wall 20 and out of the compartment 18 (or to an upper portion of the compartment 18), as shown in FIG. 12. When the item 22 is moved in this manner, the item 22 is supported both from above, by the gripping component 42, and from below by the support arm 48/support portion 50, to securely hold the item 22. Accordingly the item 22 is restrained in place, and the lifted item 22, particularly when the item 22 is a garment or another pliable item, does not unfold and drape downwardly due to the lower support provided by the support arm 48/support portion 50. Thus by reducing unfolding/draping of the item 22, the item 22 retains a more compact configuration and is less likely to snag on catch points within the system 10. In addition, by only partially lifting the item 22 prior to moving the support arm 48/support portion 50 thereunder, the items 22 are retained in their folded shape and do not drape downwardly during the gripping/lifting process.

In addition, by gripping the item 22 both above and below, the item 22 is firmly gripped, and the item 22 does not need to be encased in an outer bag. In contrast, in some other systems, the items 22 are gripped and lifted by suction applied to an outer bag, which receives the item 22 therein. However the use of such outer bags adds expense, requires additional handling of the item prior to being placed in the system, requires the end user to remove the item from the bag before using the item, which creates waste and is environmentally unfriendly.

Thus in the current system the items 22 may not be encased and/or the item 22 lack an outer covering bag (e.g. can lack an outer covering that covers more than 50% of the outer surface area of the item 22 in one case and/or that extends over more than two outer edges of the item 22 in top view) made for example of plastic, polymers, or other air impermeable material. Moreover in one particular case each item 22, as positioned in the system 10/frame 12, is folded and freely movable to an unfolded position. In other words each item 22 may be folded and may not be secured to itself (via a separable/removable item, such as clips, pins, safety pins, paper staples, paper/polymer bands, or the like) that operate to retain the item 22 in a folded configuration. The elimination of such retaining devices provides similar benefits to the reduction of the outer bags as described above. The gripping of the item 22 from both above and below, and particularly the presence and operation of the support arm 48/support portion 50, also enables heavier items to be handled than might otherwise be able to be handled. In one case, the gripping assembly 29 can grip, lift and support items 22 having a weight of at least one kilogram.

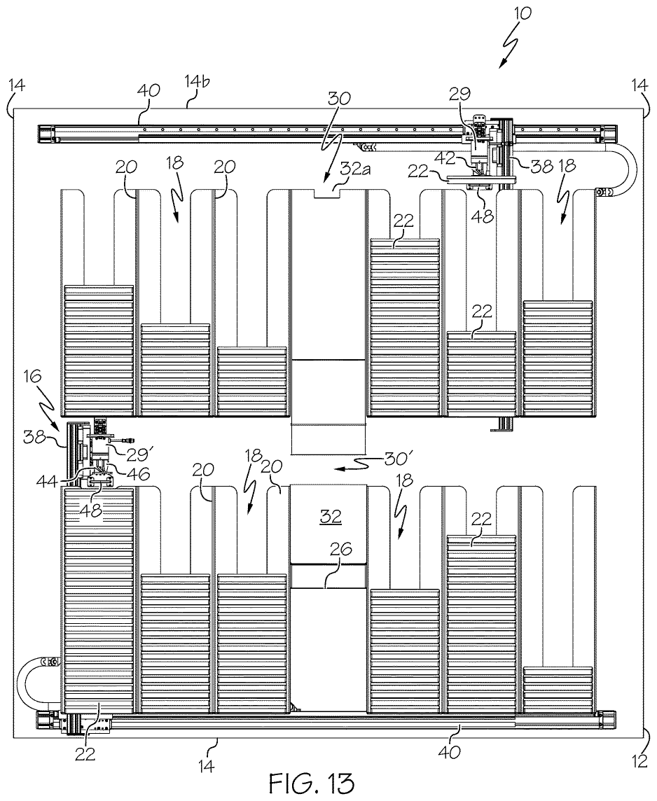

Once the item 22 is lifted and raised, the gripping assembly 29 and gripped item 22 are then moved to the drop-off location 30, such that the gripping assembly 29 and items 22 are positioned in/above the chute 32, as shown in FIG. 14. In one case, the chute 32 is defined by vertical walls 20 of adjacent associated compartments 18. The support arm 48/support portion 50 is then moved to its retracted position, and the fingers 44, 46 of the gripping component 42 are then spaced apart, releasing the item 22 and enabling the item 22 to fall through the chute 32 to the pickup location 26, as shown in FIG. 15. In one case, the gripping assembly 29 is lowered (in one case at least about 3 inches) such that at least part of the gripping assembly 29 and/or gripped item 22 is located in the chute 32, prior to releasing the gripped item 22. This can help to ensure that, once released, the gripped item 22 falls freely through the chute 32 without catching on any upper edges of the chute 32. In one case, a wall, such as a rear wall of the chute 32, may include a notch or cutout 32a (FIG. 13) to enable the gripping assembly 29 to be partially lowered into the chute.

Thus in one case the drop-off location 30 is positioned at an upper location of the chute 32, above the pickup location 26, with respect to a gravitational frame of reference. The pickup location 26 can be located at or adjacent to a bottom of the chute 32, and the drop-off location 30 and pickup location 26 can be in communication with each other. However if desired the pickup location 26 can be laterally offset from, or in some cases even positioned above, the drop-off location 30, in which case a lifting mechanism such as a conveyer or the like can be implemented to convey items from the drop-off location 30 to the pickup location 26.

The user 24 can then manually access the item 22 at the pickup location 26, and remove the item 22 from the system 10/frame 12, as shown in FIG. 16. The process can then be repeated, with the gripping assembly 29 being movable to each desired compartment 18 to grip, lift and convey each item 22 to the pickup location 26.

As noted above, the system 10/frame 12 can include the supplemental gripping assembly 29′. The supplemental gripping assembly 29 can be movable to some or all of the compartments 18, but in the illustrated embodiment the supplemental gripping assembly 29′ is movable along its associated horizontal rail 40 and is positioned below the gripping assembly 29. In some cases, the first (upper) set of compartments 18 can have a different (greater or lesser) height compared to a height of the second (lower) set of compartments 18. The different height of compartments 18 can help to provide an optimized design such that bulkier and/or more-frequently dispensed items 22 are stored in the higher-capacity compartments. In other cases, however, the first (upper) and second (lower) set of compartments 18 have the same height/capacity.

The gripping assembly 29 and the supplemental gripping assembly 29′ can be independently movable relative to each other within the system 10/frame 12 in the horizontal direction and/or vertical direction. The gripping assembly 29 and supplemental gripping assembly 29′ can each be independently positionable in (or, in the case of the gripping assembly 29, in or above) the chute 32. In one case the supplemental gripping assembly 29′ is movable to a supplemental drop-off location 30′ (see e.g. FIG. 15) to thereby move an item 22 gripped by the supplemental gripping assembly 29′ to the supplemental drop-off location 30′. The supplemental drop-off location 30′ can be positioned directly vertically below the drop-off location 30, and be in direct communication with the drop-off location 30 and/or the pickup location 26. In this manner, items dropped by the supplemental gripping assembly 29′, in the chute 32 and/or at the supplemental drop-off location 30′, can fall to the pickup location 26 and be accessed by the user 24.

As noted above, the drop-off location 30 and the supplemental drop-off location 30′ can be aligned in the vertical direction. This arrangement is enabled by independent movement of the gripping assembly 29 and the supplemental gripping assembly 29′. In particular, in some existing systems, the gripping assembly 29 and the supplemental gripping assembly 29′ are not independently movable in the horizontal direction. This means that when the gripping assembly 29 is in the drop-off location 30, the supplemental gripping assembly 29′ is in the supplemental drop-off location 30′. Thus in such systems the supplemental gripping assembly 29′ interferes with the free fall of items 22 released by the gripping assembly 29 in the chute 32. Accordingly, in such systems, diverter panels and the like must be positioned in the chute 32, and are utilized to route items 22 that are dropped by the gripping assembly 29 around the supplemental gripping assembly 29′. However such diverter panels add additional cost and provide a catch-point upon which falling items 22 can be snagged.

In contrast the independent movement of the gripping assembly 29 and the supplemental gripping assembly 29′ of the current system 10 enables the gripping assembly 29 to be positioned in the drop-off location 30 when the supplemental gripping assembly 29′ is not in the supplemental drop-off location 30′, and vice versa. Thus such an arrangement avoids interference and enables elimination of the diverter panels used in other systems.

In addition, in one embodiment the arrangement of the compartments 18 can be asymmetrical, with respect to a vertical line and/or with respect to the chute 32. For example in FIG. 15A, it can be seen that the left side of the system 10 includes three (horizontal) rows of compartments 18, while the right side of the system 10 includes two (horizontal) rows of compartments 18. In the particular embodiment of FIG. 15A, the left side of the system 10 has two relatively short, upper rows of compartments 18, and a relatively long, lower row of compartments 18 (each row having three columns of compartments 18 in the illustrated embodiment). In contrast, the right side of the system 10 of the embodiment of FIG. 15A has an upper, relatively long row of compartments 18, and a lower, relatively long row of compartments 18, with no middle or intermediate row therebetween.

In one case, if desired, the upper gripping assembly 29 can be moved vertically down (parallel to and/or in the chute 32) and then laterally (to the left, in the illustrated embodiment) toward the intermediate row of compartments, in the path of arrow 35, to access the middle/intermediate row of compartments 18. In yet another case, if desired, a third/middle gripping assembly (not shown), which can access the middle row of compartments 18, can be implemented. The controller 34 can be configured to control movement of each gripping assembly 29, 29′ (and others, if desired) such that each gripping assembly can access all of the compartments 18 in the system 10 and/or compartments 18 on both sides of the chute 32.

Thus the arrangement of compartments 18 in the embodiment of FIG. 15A is not symmetrical with regard to a vertical centerline of the system 10/frame 12 (and is not symmetrical with regard to the chute 32 and/or any other vertical line). This flexibility in arrangement can enable the system 10 to be optimized to accommodate various numbers of items 22 in various arrangements. It should be understood that the compartments 18 on the right side of the chute 32 can instead or also include a middle/intermediate row of compartments 18. It should also be understood that the lower row of compartments 18 of FIG. 15, on either the left or right side, can be “split” into multiple rows of compartments (e.g. the not only the upper left row of compartments of FIG. 15 can be split into multiple rows of compartments 18).

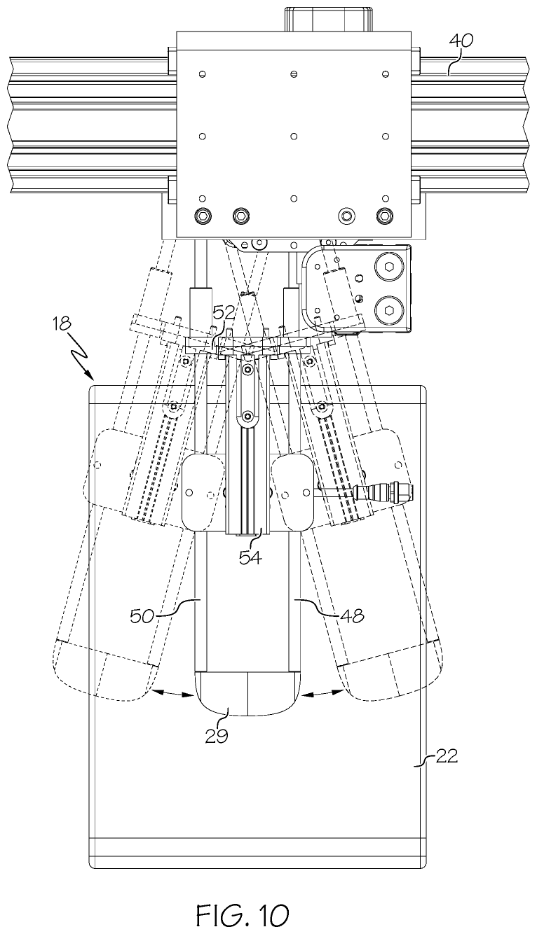

With reference to FIG. 10, in one embodiment each gripping assembly 29 is movable/rotatable in a horizontal plane/horizontal direction, when the gripping assembly 29 is positioned adjacent to the item 22 to be gripped, to thereby adjust a location at which the item 22 is gripped. In particular, the gripping assembly 29 of FIG. 10 is pivotable about a vertically extending axis, up to fifteen degrees in both direction in one case, or up to twenty-five degrees in another case. The movable/pivotable nature of the gripping assembly 29 can enable the gripping assembly 29 to be moved to an optimal position to grip an item 22. For example, when the item 22 takes the form of a garment, the item 22 can include buttons or other fasteners, pockets, seams/openings or other features that may be desired to be avoided to be gripped by the gripping component 42. The movable/pivotable nature of the gripping assembly 29 enables it to be moved to avoid such features. The gripping assembly 29 can, in some cases, be preprogrammed to avoid certain features that are known to be regularly positioned at a predetermined position of the item 22. In other cases, the gripping assembly 29 can be rotated by control logic, artificial intelligence or the like that is programmed/trained to rotate the gripping assembly 29 based upon output from an optical sensor.

With reference to FIG. 3, the system 10 can include or utilize various markers 80 associated with each compartment 18. In one case the markers 80 include maximum fill point markers 80a, current fill point markers 80b, and empty point markers 80c, associated with each compartment 18. Although FIG. 3 only illustrates select compartments 18 having the markers 80, each compartment 18 can include a maximum fill point marker 80a, a current fill point marker 80b and an empty point marker 80c so that the system 10 and/or an operator can track the fill status of each compartment 18.

Each marker 80 is configured to be visually identifiable via an operator, and/or via a camera or other image capture device. Each maximum fill point marker 80a can be located at or adjacent to the highest point of the compartment 18 at which items 22 can be stacked, and thus identifies a maximum fill point for that compartment 18. Each current fill point marker 80b can be located at or adjacent to the highest point of the items 22 stored in the compartment 18, and thus identifies a current fill point of the associated compartment 18. The empty point marker 80c can be located at or adjacent to the lowest point of the compartment 18 upon which items 22 can be stacked, and thus identifies an empty point of that compartment 18.

The maximum fill point markers 80a and the empty point markers 80c can each be fixedly coupled to the system 10/frame 12, and are not moved or movable during use of the system 10 or during dispensing operations. Conversely, the current fill point markers 80b can be vertically movable and thus move vertically depending upon the number of items 22 in the associated compartment 18. Each current fill point marker 80b can in one case be manually movable, and moved to the appropriate position by an operator or the like. Alternatively, each current fill point marker 80b can be automatically movable, and moved to the appropriate position by the system 10/controller and/or movable by a motor or the like. Further alternatively, each current fill point marker 80b can be semi-manually movable, for example configured to automatically move vertically downwardly by gravity without any manual operation, such as by sitting on top of the stack of items 22, but needs to be manually moved upwardly to the top of the stack when items 22 are replenished.

Thus each maximum fill point marker 80a and associated empty point marker 80c are spaced away from each other in the vertical direction, by a distance which represents the maximum capacity of the compartment 18. Each current fill point marker 80b is movable in the vertical direction to indicate a fill status of the associated compartment 18.

The markers 80 provide maximum capacity and/or current capacity information to enable the system 10/controller 34, or some other system, to determine the fill status of each compartment 18. In particular, a camera or other digital imaging device can capture or obtain an image of the markers 80, and determine their relative vertical positions to determine the fill status. A maximum capacity can be determined by the vertical distance between the maximum fill point marker 80a and the empty point marker 80c, and a fill status can be determined by measuring and/or calculating the vertical distance between the current fill point marker 80b and the associated empty point marker 80c (and/or in some cases between the current fill point marker 80b and the fill point marker 80a). Knowing the number of items 22 that are required to fill the associated compartment 18, and/or knowing the vertical space occupied by each item 22, the number of items 22 located in the compartment 18 can then be determined.

In one case, the number of items 22 in a compartment 18 can be determined by linear interpolation, for example via the following equation: ((Height of Current Fill Point Marker Height of Empty Point Marker)/(Height of Maximum Fill Point Marker-Height of Empty Point Marker))×(Maximum Number of Items Storeable in Compartment). For example, if:
Height of Empty Point Marker=10″
Height of Current Fill Point Marker=25″
Height of Maximum Fill Point Marker=30″; and
Maximum Number of Items Storeable in Compartment=40 items
   then the number of items in the compartment is calculated as ((25−10)/(30−10))×40=30 items.

In one case, the operator may have access to an app stored on their mobile phone or other device. Using the camera/photo functionality the app may be able to recognize the various markers 80 and automatically calculate the number of items 22 in each compartment 18. In another case the app is configured to automatically identify certain reference points on/in the frame 12, and the user of the phone is cued by the app to line up the reference points at the desired position to aid in image capture. In this or another case, the markers 80 are not utilized, and the camera/controller/app can automatically determine the height of the empty point, current fill point and maximum fill point, for example via image recognition, and make the desired calculations. In yet another embodiment, system 10/frame 12 has its own, internal camera or image sensing devices that can be used to sense the markers 80 and/or otherwise determine the empty point, current fill point and maximum fill point for each compartment, and make the desired calculations.

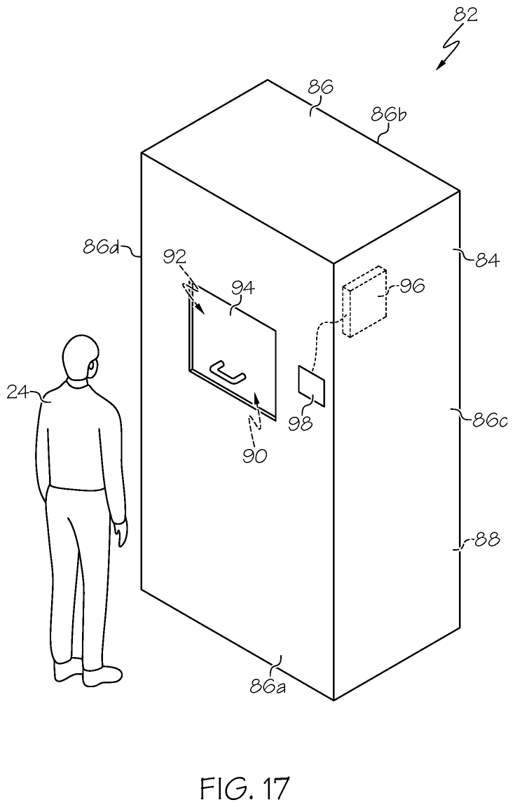

FIG. 17 illustrates a handling system, in the form of a return system 82 including a frame 84, which can be utilized to receive any of a wide variety of items 22 for return and further processing/handling. The system 82/frame 84 can include a set of outer walls 86, defining an inner cavity 88 therein. The system 82/frame 84 can be configured such that the inner cavity 88 is not directly accessible to a user 24 positioned outside the system 82/frame 84. In particular, the outer walls 86 can generally entirely cover the system 82/frame 84 and the inner cavity 88 and/or block access to the inner cavity 88 from a user 24 positioned outside the system 82/frame 84. One or more of a front wall 86a, rear wall 86b and/or the side walls 86c, 86d can, in certain cases, be partially and/or fully removable to provide access to the inner cavity 88 for service or maintenance, and to remove items 22 positioned in the system 82/frame 84/inner cavity 88. However such direct access to the inner cavity 88 may be restricted to certain authorized users, such as maintenance and service personnel via locks, secure fasteners, and the like, and most users of the system 82 would not have direct access to the inner cavity 88.

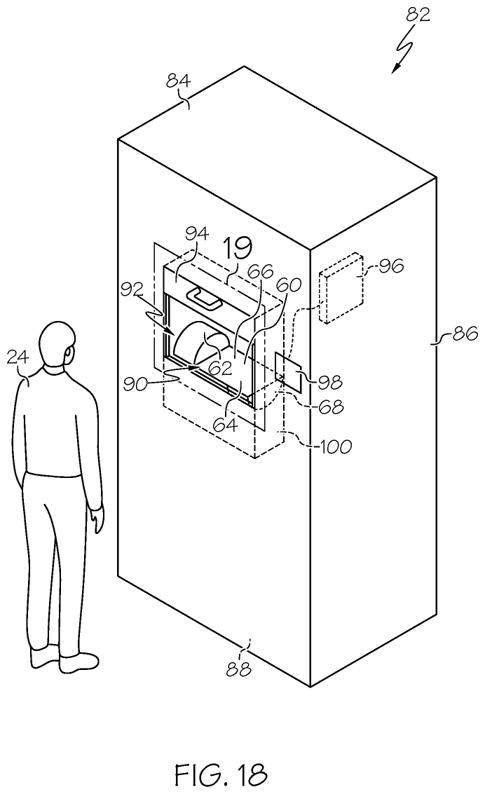

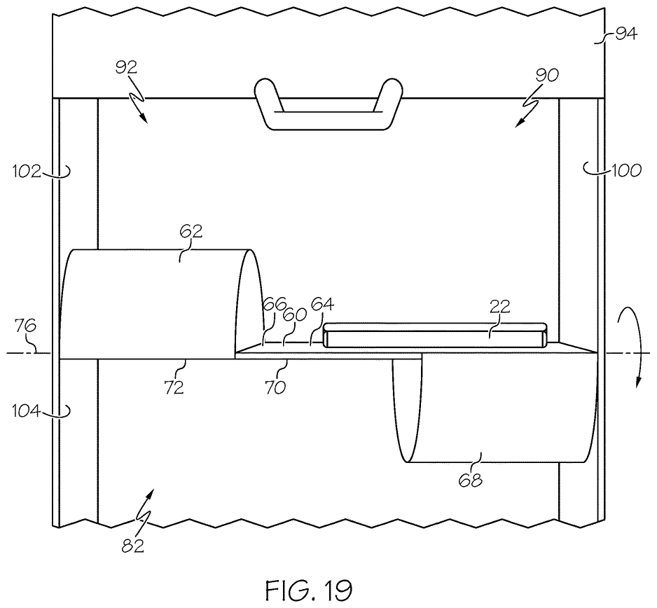

The system 82/frame 84 can include a dropoff location 90 (FIG. 18), which in one case is not covered by the outer walls 86 and/or is defined by or accessible via an opening 92 in the front wall 86a. The dropoff location 90 can be directly accessible to the user 24 positioned outside the frame 84/inner cavity 88. In one case the system 82/frame 84 includes an openable door, flap or the like 94 that selectively covers the opening 92, as shown in FIG. 17. The door 94 can in one case be manually opened by the user 24, while the user's torso remains positioned outside the frame 84/inner cavity 88 to access the dropoff location 90 and place an item 22 in/at the dropoff location 90 (see FIG. 19). However the system 82/dropoff location 90 does not necessarily need to include the door 94 and instead the dropoff location 90/opening 92 may be directly accessible to the user 24, without having to open a door or the like. Moreover, if the door 94 is utilized, opening and/or closing of the door 94 can in one case be controlled by the controller 96, described below.

The system 82/frame 84 may include or be operatively coupled to a controller 96, which in turn can include and/or be operatively coupled to user interface 98 (see FIGS. 17 and 18). The user 24 can interact with the user interface 98, to identify/authenticate the user 24, identify the returned items 22, or provide other information. The controller 96 may take the form of a processor, CPU, computer or the like, and the user interface 98 can take the form of a keypad, touch screen, keyboard, mouse, track ball, audio input device, or the like, and combinations thereof. In certain cases the controller 96 can be remotely positioned and/or the user interface 98 is also or instead remotely positioned, such as being presented to the user 24 via an app on the user's mobile phone, mobile device or the like.

The system 82/frame 84 can be used to accept and store any of a wide variety of items, products or the like 22 (collectively terms “items” herein) so long as such items 22 can be physically accommodated in the system 82/frame 84. Thus the items 22 can include, but are not limited to, garments, clothing, textiles including sheets, blankets and bedding, masks, gloves and other personal protective equipment, medical equipment, pharmaceuticals, retail merchandise, parts, components, work pieces, hardware, electronic equipment, food/groceries, and like. In one case items 22 are garments/clothing items.

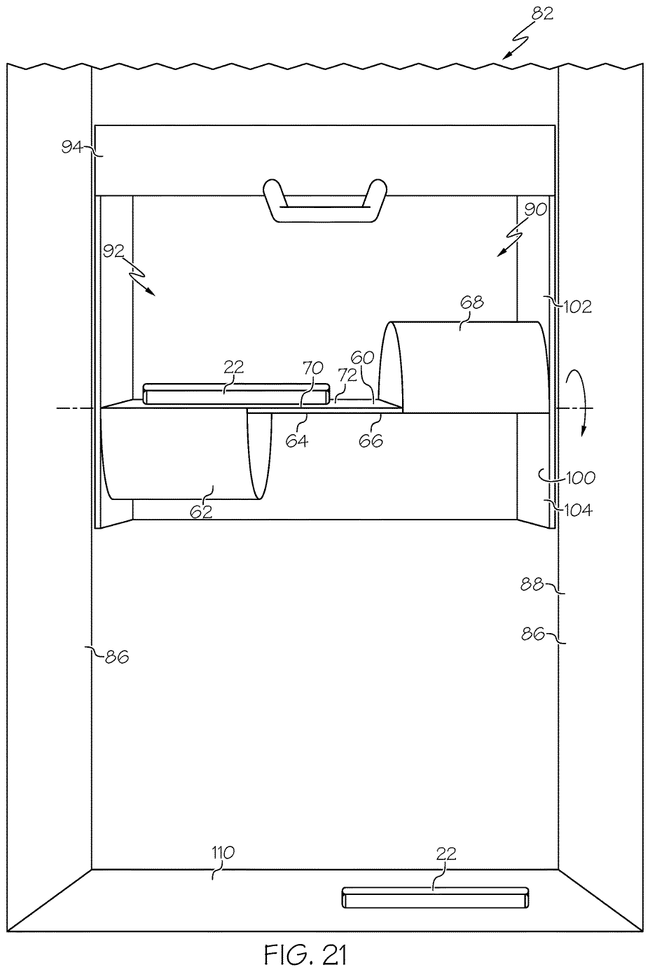

With reference to FIGS. 18 and 21, the system 82/frame 84 can include a vertically oriented chute 100 positioned in the cavity 88. The chute 100 may be in communication with the opening 92 and/or dropoff location 90. The chute 100, or lower portions thereof may, in one case, be manually inaccessible to the user 24 when the user 24 is positioned outside the system 82/frame 86/inner cavity 88, regardless of whether the door 94 (if utilized) is open or closed. The chute 100 can have an upper portion 102 that constitutes and/or is in communication with the dropoff location 90, and can include a bottom portion 104 positioned vertically below the upper portion 102 and/or dropoff location 90.

The system 82/frame 84 can include a distribution plate 60 positioned in and closely received in the chute 100. Alternatively the distribution plate 60 can be positioned adjacent to (e.g. directly above, in one case) the chute 100. The distribution plate 60 can have a surface area that substantially corresponds to a cross sectional area of the chute 100, in the portion of the chute 100 in which the distribution plate 60 is located, or located adjacent to. The chute 100 may also include and/or be defined by, at its lower portions in the illustrated embodiment, the walls 86 shown in FIG. 21, and or other walls or separators.

The distribution plate 60 can be positioned vertically between the upper portion 102/dropoff location 90 and the bottom portion 104 of the chute 100, and may block manual access to the chute 100, or at least the bottom portion of the chute 100 and/or lower portion of the cavity 88. With reference to FIG. 19, the distribution plate 60 can include a first protrusion 62 and a generally flat first landing space 64 on a first side 66 thereof (the upper side when the distribution plate 60 is in the position shown in FIG. 19). The first protrusion 62 is located at or adjacent to a first lateral end of the distribution plate 60 (e.g. in the left-to-right or horizontal direction; the left end in the illustrated embodiment) and the first landing space 64 is located at or adjacent to the second, opposite lateral end (the right end in the illustrated embodiment) of the distribution plate 60. The distribution plate 60 can also include a second protrusion 68 and a generally flat second landing space 70 on a second, opposite side 72 thereof (the lower side in FIG. 19). The second protrusion 68 is located at or adjacent to the second lateral end of the distribution plate 60 and the second landing space 70 is located at or adjacent to the first lateral end of the distribution plate 60. Each landing space 64, 70 can be generally flat and/or planar, or at least flatter (have a greater flatness) than the association protrusions 62, 68. The distribution plate 60 is rotatable, at least 270 degrees in one case, and at least 360 degrees in another case, about a horizontal axis 76.

The first 66 and second sides 72 can be the sides of greatest surface area of the distribution plate 60, and the first and second lateral ends can be spaced apart along the longest dimension (length) of the distribution plate 60. Each landing space 64, 70 can take up or constitute the remainder of the associated first 66 or second 72 side that is not taken up by/defined by the associated protrusion 62, 68. When the first protrusion 62 is on an upper side of the distribution plate 60 as shown in FIG. 19, the first protrusion 62 is configured to prompt, guide or cue, such as by visual cues (collectively, “cue”) a user 24 to place items 22 on the first landing space 64, and not on the first protrusion 62, since users 24 are typically expected to place items 22 on a flatter and/or more stable surface. In the illustrated embodiment, each protrusion 62, 68 is shaped as a semi-cylinder, and the user 24 would know that the protrusion inherently provides an uneven/unstable surface for receiving items 22 thereon. In addition, the distribution plate 60 may include text, colors (e.g. red on the protrusions 62, 68 and/or green on the landing spaces 64, 70) or other indicia to cue a user 24 to place an item 22 on the landing spaces 64, 70 and not on the protrusions 62, 68.

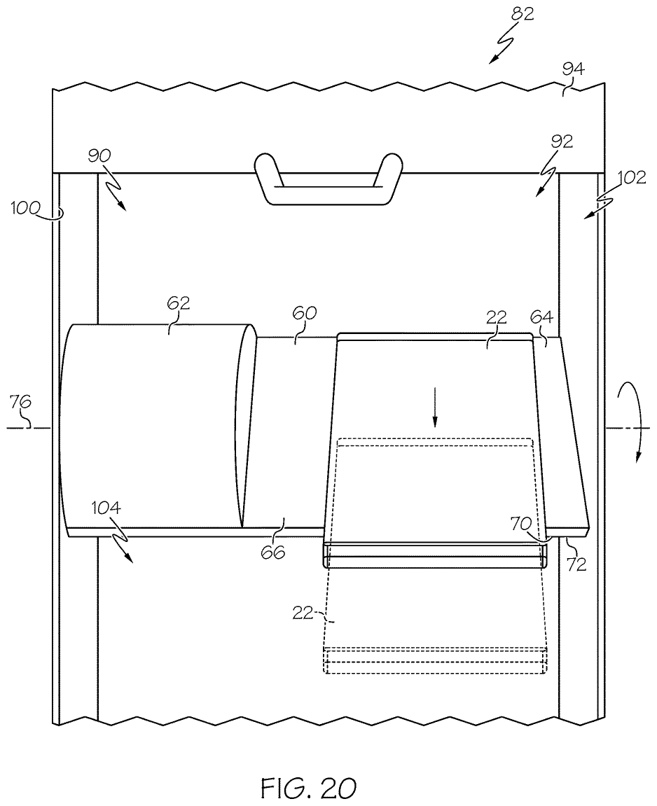

Once an item 22 (or multiple items 22) is known or sensed to have been positioned on the first landing space 64 (and/or when the user 24 inputs to the controller 96 that the item 22 is positioned on the distribution plate 60 and/or when the user 24 closes the door 94), the system 82 in one case can take an image or picture of the item 22 positioned on the distribution plate 60 for identification and/or tracking purposes. The distribution plate 60 can then be caused to pivot (such as via a motor, not shown) about the axis 76, until the item(s) 22 located on the first landing space 64 slides off of the distribution plate 60, as shown in FIG. 20. Thus items 22 in this case tend to fall on the right side of the chute 100 and are deposited on the right side of the floor 110 of the frame 84/cavity 88 (see FIG. 21), since the first landing space 64 is located on the right side of the distribution plate 60.

The distribution plate 60 can then continue to rotate about the axis 76, one hundred and eighty degrees until the distribution plate 60 is positioned such that the second protrusion 68, the second landing space 70 and the second side 72 are positioned as the upper surface of the distribution plate 60, as shown in FIG. 21. When in this position the second landing space 70 (and first landing space 64) are oriented horizontally, and the second side 72 is the upper side of the distribution plate 60 and is presented to a user 24. Due to the configuration of the second protrusion 68 and the second landing space 70, the user 24 is cued to position items 22 on the second landing space 70, and not on the second protrusion 68.

Once an item 22 (or multiple items 22) is known or sensed to have been positioned on the second landing space 70 (or when the user 24 inputs to the controller 96 that the item 22 is positioned on the distribution plate 60 and/or when the user 24 closes the door 94), an image of the item 22 may be captured and the distribution plate 60 can be caused to pivot about the axis 76, until the item(s) 22 located on the second landing space 70 slides off of the distribution plate 60. Thus items 22 in this case fall through the left side of the chute 100 and are deposited on the left side of floor 110.

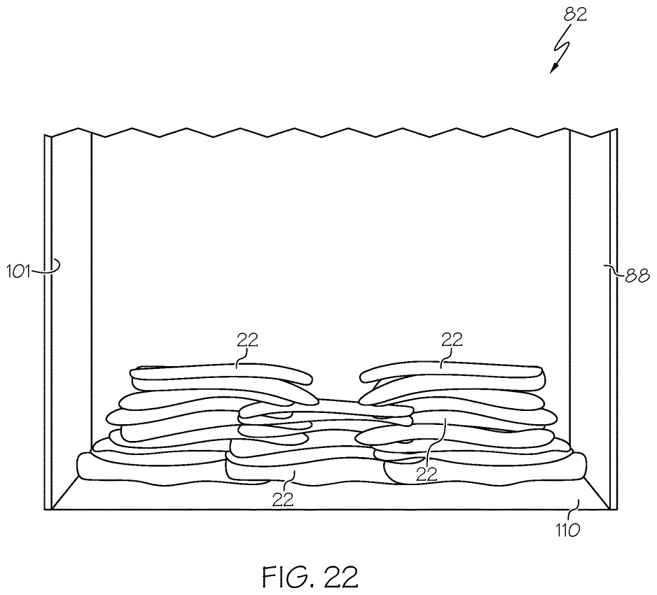

It can therefore be seen that as the distribution plate 60 is regularly pivoted to deposit items 22 at the bottom portion of the chute 100/on the floor 110, the distribution plate 60 dispenses items 22 in an alternating side of the floor 110, in a right-left-right-left pattern. The distribution plate 60, and operation thereof, helps to ensure a relatively even pile of items 22 are deposited on the floor 110, as shown in FIG. 22. Thus helps to increase the capacity of the number of items 22 the system 82/frame 84 can store. In contrast, in many existing systems, returned items 22 all fall toward the middle of the floor and form a pyramid-type stack. Under that arrangement the pile of returned items reaches a relatively high height relatively quickly, which can limit the storage capacity and/or lead to jams within the system.

It can be desired for the protrusions 62, 68 to be of a sufficient amount of surface area of the distribution plate 60/sides 66, 72 to ensure sufficient spacing of deposited items 22. The protrusions 62, 68 may also be desired to take up a sufficient amount of width of the plate 60/sides 66, 72 to ensure items 22 are placed onto the associated landing space 64, 70. In one case each protrusion 62, 68 covers greater than 10 percent and/or less than 50 percent and/or less than 75 percent of the surface area (e.g. in top view) of the associated side 66, 72 of the distribution plate 60. Conversely, in one case each protrusion 62, 68 covers at least 10 percent and/or at least 25 percent and/or at least 50 percent of the surface area (e.g. in top view) of the associated side 66, 72 of the distribution plate 60.

In addition the first 62 and second 68 protrusions can each extend at least about 90 percent of a width of the associated side 66, 72 distribution plate 60. In one case each protrusion 62, 68 extends less than one half of the length of the plate 60/sides 66, 72 to provide sufficient surface area for the item 22. In one case the highest portion of the first 62 and second 68 protrusions has height of at least half of the width of the plate 60 in one case, or at least half of the length of the plate 60 in another case. In one case the highest portion of the first 62 and second 68 protrusions has a height of less than the width of the plate 60 in one case, or less than double the width of the plate 60 in one case, or less than the length of the plate 60 in yet another case. However it should be understood that each of these parameters can be varied as desired.

Once the items 22 are deposited on the floor 110, as shown in FIG. 22, the items 22 can remain there until retrieved by a worker or the like, and/or may be automatically conveyed to another location within, or even outside, the system 82 and/or frame 84. In addition, while the distribution plate 60 is described and shown as being used as part of a return system 82, it should be understood that the distribution plate 60 can be used with items 22 in any of a wide variety of settings and systems, including dispensing systems such as the system 10 described herein, or nearly any system, device or method where items 22 are handled, moved, stored, received and/or dispensed, and where a relatively even distribution of items 22 may be desired.

Although the invention is shown and described with respect to certain embodiments, it should be clear that modifications will occur to those skilled in the art upon reading and understanding the specification, and the present invention includes all such modifications.

1. A dispensing system comprising:
a frame including a plurality of compartments, each compartment being configured to receive at least one item therein, the frame further including a pickup location; and
a gripping assembly including gripping component having a pair of fingers that are movable closer to and further from each other to thereby selectively grip an item therebetween, the gripping assembly further including a support arm positionable below the gripping component to selectively support the gripped item thereon, wherein the gripping assembly is movable to the plurality of compartments and is movable to a drop-off location that is in communication with the pickup location to thereby deliver the gripped item to the pickup location.

2. The system of claim 1 wherein the gripping component and the support arm are configured to move together during movement of the gripping assembly.

3. The system of claim 1 wherein the support arm is configured to be movable relative to the gripping component.

4. The system of claim 3 wherein the gripping component is configured to grip and partially lift a gripped item, and wherein the support arm is configured to move under the partially lifted item to support the partially lifted item thereunder.

5. The system of claim 4 wherein the support arm is movable in a horizontal direction between a retracted position wherein no portion of the support arm is positioned directly below gripping component, and an engaged position wherein at least part of the arm is positioned directly below the gripping component.

6. The system of claim 1 wherein the dispensing system includes a controller operatively coupled to the gripping assembly, and wherein the controller is configured to cause the gripping component to grip and partially lift a gripped item, and is configured to thereafter cause the support arm to move under the partially lifted item to support the partially lifted item thereunder, such that the partially lifted and supported item can then be fully lifted and moved to the drop-off location.

7. The system of claim 1 wherein the gripping assembly is movable in a horizontal direction and a vertical direction within the frame to enable the gripping assembly to move to the plurality of compartments.

8. (canceled)

9. The system of claim 1 further comprising a plurality of items, each item being a piece of clothing located in one of the compartments, wherein each item is not encased in an outer bag, and wherein each item is folded and is not secured in a manner to retain the item in the folded configuration.

10. The system of claim 1 wherein the plurality of compartments are arranged in a series of rows and columns, wherein the gripping assembly is entirely positioned in the frame, wherein the frame is configurable such that the plurality of compartments are not directly accessible to a user positioned outside the frame, wherein the system includes a chute positioned below the drop-off location, wherein the pickup location is located at or adjacent to a bottom of the chute, and wherein the frame is configured such that items positioned in the pickup location are directly accessible to the user positioned outside the frame.

11. (canceled)

12. The system of claim 1 further including a supplemental gripping assembly, wherein the supplemental gripping assembly is movable to at least some of the plurality of compartments and is movable to a supplemental drop-off location to thereby move an item gripped by the supplemental gripping assembly to the supplemental drop-off location, wherein the gripping assembly and the supplemental gripping assembly are independently movable relative to each other at least in the horizontal direction.

13. The system of claim 12 wherein the drop-off location and the supplemental drop-off location are aligned in the vertical direction, and wherein the drop-off location and the supplemental drop-off location are in direct communication with each other.

14. The system of claim 13 wherein the gripping assembly is positionable in the drop-off location when the supplemental gripping assembly is not in the supplemental drop-off location.

15. The system of claim 12 wherein the system includes a chute at least partially positioned below and in communication with the drop-off location and the supplemental drop-off location, wherein the pickup location is positioned at or adjacent to a bottom of the chute, wherein the drop-off location and the supplemental drop-off location are vertically aligned and both positioned above the pickup location, wherein the frame is configured such that items positioned in the pickup location are directly accessible to a user positioned outside the frame, and wherein the gripping assembly and the supplemental gripping assembly are both positionable in or above the chute.

16. (canceled)

17. The system of claim 1 further including a maximum fill point marker, a current fill point marker and an empty point marker associated with each compartment, wherein the maximum fill point marker and empty point marker are spaced away from each other in the vertical direction, and wherein the current fill point marker is movable in the vertical direction to indicate a fill status of the associated compartment.

18. The system of claim 17 further comprising a controller configured to receive information relating to a vertical position of each maximum fill point marker, current fill point marker and empty point marker, and wherein the controller is configured to calculate a number of items in each compartment based on the received information.

19. A method comprising:
accessing a dispensing system comprising a frame including a plurality of compartments, each compartment receiving at least one item therein, the frame including a pickup location, the dispensing system further including support arm, and a gripping assembly including gripping component having a pair of fingers;
moving the gripping assembly to one of the plurality of compartments;
causing the pair of fingers to move toward each other to thereby grip an item, positioned in one of the plurality of compartments, therebetween;
causing the support arm to move below the gripped item to at least partially support the gripped item thereon;
moving the gripping assembly, and the gripped and supported item, to a drop-off location; and
at the drop-off location, dropping the item such that the item falls to the pickup location.

20. The method of claim 19 further comprising, after the first causing step and before the second causing step, moving the gripping assembly vertically upwardly to only partially lift the gripping item.

21-23. (canceled)

24. A dispensing system comprising:
a frame including a plurality of compartments, each compartment being configured to receive at least one item therein, the frame further including a pickup location;
a first gripping assembly configured to grip an item, wherein the first gripping assembly is movable to at least some of the plurality of compartments and is movable to a first drop-off location that is in communication with the pickup location to thereby deliver the gripped item to the pickup location; and
a second gripping assembly configured to grip an item, wherein the second gripping assembly is movable to at least some of the plurality of compartments and is movable to a second drop-off location that is in communication with the pickup location to thereby deliver the gripped item to the pickup location, wherein the first gripping assembly and the second gripping assembly are independently movable in the horizontal direction relative to each other.

25. The system of claim 24 wherein the first drop-off location and the second drop-off location are spaced apart but aligned in the vertical direction and are in direct communication with each other.

26. The system of claim 24 wherein the first gripping assembly is positionable in the first drop-off location when the second gripping assembly is not in the second drop-off location.

27. (canceled)

28. The system of claim 24 wherein the first gripping assembly and the second gripping assembly each include a gripping component having a pair of fingers that are movable closer to and further from each other to thereby selectively grip an item therebetween, and a support arm positionable below the gripping component to support the gripped item thereon.

29. The system of claim 24 wherein the first gripping assembly and the second gripping assembly are independently movable within the frame in the vertical direction relative to each other.

30-39. (canceled)
